(19) United States
(12) Patent Application Publication
(10) Pub. No.: US 2003/0135007 A1
(43) Pub. Date: Jul. 17, 2003

(54) Catalysts for preparing polyisocyanates containing isocyanurate groups, and their use

(75) Inventors: Michael Ewald, Marl (DE); Manuela Windmueller, Marl (DE); Waltraud Poersch, Herne (DE); Stephan Kohlstruk, Duelmen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/307,923

(22) Filed: Dec. 3, 2002

(30) Foreign Application Priority Data
Dec. 5, 2001 (DE) 101 59 803.3

(51) Int. Cl. C08G 77/04

(52) U.S. Cl. 528/27; 528/28

(57) ABSTRACT

A silicon based catalyst containing the reaction product of a silylamide and a fluoride is used to react isocyanate compounds. The catalyst is prepared in situ or before the reaction of the isocyanate. The catalyst is capable of trimerizing isocyanates.

### BACKGROUND OF THE INVENTION

1. Field of the Invention

The invention relates to catalysts and processes for preparing polyisocyanates containing isocyanurate groups, the polyisocyanates thus prepared and their use.

2. Discussion of the Background

For high-grade one- and two-component polyurethane coating materials featuring high light stability and weathering stability, the isocyanate component may contain, in particular, polyisocyanate mixtures containing isocyanurate and uretdione groups. The oligomerization or polymerization of isocyanates to give such polyisocyanates has been known for a long time. A range of preparation processes have been developed which may differ from one another in catalyst selection, the organic isocyanate components, or other technical parameters of the process (cf. e.g. GB Patent 1391066, EP 82 987, DE 39 02 078, EP 339 396, EP 224 165; see also H. J. Laas et al. in J. Prakt. Chem. 336 (1994), 185 ff.).

Isocyanates suitable for trimerization, such as cycloaliphatic diisocyanates, aliphatic diisocyanates and higher polyisocyanates, can be prepared by a variety of methods (Annalen der Chemie 562 (1949), 75 ff.). Processes practiced on an industry scale include the phosgenation of organic polyamines to the corresponding polycarbamoyl chlorides and the subsequent thermal cleavage of these chlorides into organic polyisocyanates and hydrogen chloride. Alternatively, organic polyisocyanates can be prepared without the use of phosgene, i.e., by phosgene-free processes. According to EP-B-0 126 299, EP 126 300 and EP 355 443, (cyclo)aliphatic diisocyanates such as 1,6-hexamethylene diisocyanate (HDI) and/or isomeric aliphatic diisocyanates having 6 carbon atoms in the alkylene radical and 1-isocyanato-3-isocyanatomethyl-3,5,5-trimethylcyclohexane (isophorone diisocyanate or IPDI), can be prepared by reaction of the parent (cyclo)aliphatic diamines with urea and alcohols to give (cyclo)aliphatic biscarbamic esters and subsequent thermal cleavage into the corresponding diisocyanates and alcohols.

For oligomerization, the (cyclo)aliphatic diisocyanates are reacted in the presence of a catalyst, with or without the use of solvents and/or auxiliaries, until the desired degree of conversion has been achieved. Partial trimerization is used when the target conversion is generally well below 100%. After oligomerization, the reaction is terminated by deactivating the catalyst and the excess monomeric diisocyanate is usually separated off, generally by flash or thin-film distillation. Deactivation is carried out thermally or by adding a catalyst inhibitor. Suitable examples of catalyst inhibitors include acids such as p-toluenesulfonic acid or bis(2-ethylhexyl) phosphate, alkylating agents or acylating reagents.

Tertiary amines, phosphines, alkali metal phenoxides, amino silanes, quaternary ammonium hydroxides or quaternary ammonium carbonates may be used as catalysts for the trimerizing isocyanates to polyisocyanates containing isocyanurate and, if desired, uretdione groups. Highly suitable oligomerization catalysts also include hydroxides, halides or carboxylates of hydroxyalkylammonium ions (cf., e.g., EP 351 873, EP 798 299, U.S. Pat. No. 5,290,902), alkali metal salts, tin salts, zinc salts, and lead salts of alkylcarboxylic acids. Depending on the catalysts, the use of various cocatalysts such as OH-functionalized compounds or Mannich bases composed of secondary amines and aldehydes or ketones is also possible.

Depending on the type of catalyst used and the reaction temperature, polyisocyanates with different proportions of isocyanurate and/or uretdione groups may be obtained. The products are usually clear but may also have a yellow coloration depending on catalyst type, diisocyanate quality, reaction temperature and reaction regime. For the preparation of high-grade polyurethane coating materials, however, products whose color number is as low as possible are desired.

Several criteria may be used to select an appropriate catalyst. Quaternary hydroxylalkylammonium carboxylates offer advantages as oligomerization catalysts for trimerizing isocyanates on an industrial scale. These choline-type catalysts are thermally labile. It is unnecessary to stop the trimerization on reaching the desired conversion by adding potentially quality-lowering catalyst inhibitors. Instead, targeted thermal deactivation allows optimum process control. The thermal ability also affords advantages from the standpoint of process safety. There is no possibility of uncontrolled reaction “runaway” provided the amount of catalyst added does not exceed the customary level.

Aminosilyl compounds have proven advantageous for preparing high color quality polyisocyanates containing isocyanurate groups (U.S. Pat. No. 4,412,073, U.S. Pat. No. 4,537,961, U.S. Pat. No. 4,675,401, U.S. Pat. No. 4,697,014). In addition, they permit safe reaction control and can easily be deactivated using water or alcohols.

Aminosilyl catalysts however, have the disadvantage of low catalytic activity, so that economically viable space-time yields can be realized only when relatively large quantities of catalyst are used. This, however, is associated with further disadvantages. First of all, it may significantly increase the catalyst cost since deactivation irreversibly destroys the catalyst which cannot be recycled into the process after deactivation. Furthermore, relatively large amounts of the deactivated catalysts inevitably get into the product, with possibly adverse consequences on the product's properties.

There is therefore a need for Si-based catalysts for preparing isocyanurate-containing polyisocyanates that do not have the disadvantages of the aminosilyl compounds of the prior art.

### SUMMARY OF THE INVENTION

Accordingly, it is an object of the present invention, to provide novel Si-based catalysts for preparing polyisocyanates containing isocyanurate groups, which provide significantly heightened activity while permitting safe reaction control and process safety.

The invention provides a catalyst for the trimerization of isocyanates, which is a composition comprising the reaction product of

A) compounds of the general formula I

R_{(4-q)}Si(NR¹R²)_{q} (I),

in which q=1 or 2,

R simultaneously or independently of one another stands for a saturated or unsaturated, linear or branched aliphatic or cycloaliphatic radical or aryl, aralkyl, or alkylaryl radical having from 1 to 16 carbon atoms, and two radicals R can be linked with one another via an alkylene bridge,

R¹ represents R, SiR₃ or an amide radical of formula (II)

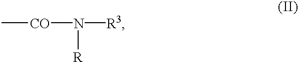

R² is R or H, where R² may be limited to R¹ via an alkylene bridge when R¹ is not an amide radical,

R³ is R or SiR₃, and

B) one or more compounds selected from alkali metal fluorides, alkaline earth metal fluorides, phosphonium fluorides, alkylarylaminosulfur trifluorides, dialkylaminosulfur trifluorides, diarylaminosulfur trifluorides, tetraalkylammonium triphenyldifluorosilicates, tetraalkylammonium triphenyldifluorostannates, and tetraalkylammonium hexafluorosilicates, aminophosphonium fluorides of the general formula (III)

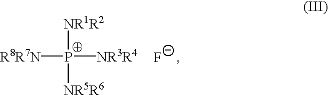

where R¹, R², R³, R⁴, R⁵, R⁶, R⁷, and R⁸ are branched or else unbranched aliphatic, optionally alkoxy-substituted alkyl radicals having from 1 to 8 carbon atoms and where in each case the pairings R¹ and R², R³ and R⁴, R⁵ and R⁶ and R⁷ and R⁸ may be linked to one another via an alkylene bridge, which where appropriate may also contain the heteroatoms O, S or N,

in a ratio 1/100>A/B>100/1.

The invention also provides compounds composed of the reaction product of

A) compounds of the general formula I

R_{(4-q)}Si(NR¹R²)_{q} (I),

in which q=1 or 2,

R simultaneously or independently of one another stands for a saturated or unsaturated, linear or branched aliphatic or cycloaliphatic radical or aryl, aralkyl, or alkylaryl radical having from 1 to 16 carbon atoms, and two radicals R can be linked with one another via an alkylene bridge,

R¹ represents R, SiR₃ or an amide radical of formula (II)

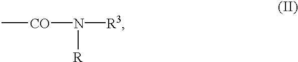

R² is R or H, it being possible for R², if R¹ is not an amide radical, to be linked to R¹ via an alkylene bridge,

R³ is R or SiR₃, and

B) compounds selected from alkali metal fluorides, alkaline earth metal fluorides, phosphazenium fluorides, alkylarylaminosulfur trifluorides, dialkylaminosulfur trifluorides, diarylamino-sulfur trifluorides, tetraalkylammonium triphenyldifluorosilicates, tetraalkylammonium triphenyldifluorostannates, and tetraalkylammonium hexafluorosilicates, aminophosphonium fluorides of the general formula (III)

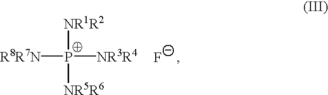

where R¹, R², R³, R⁴, R⁵, R⁶, R⁷, and R⁸ are branched or unbranched aliphatic, optionally alkoxy-substituted alkyl radicals having from 1 to 8 carbon atoms and where in each case the pairings R¹ and R² and also R³ and R⁴ and also R⁵ and R⁶ and also R⁷ and R⁸ may be linked to one another via an alkylene bridge, which where appropriate may also contain the heteroatoms O, S or N,

in a ratio 1/100>A/B>100/1.

The reaction products may contain a composition wherein A) and B) are completely reacted or the composition may contain partly reacted A) and/or B) in a quantity that is greater than or less than the amount of the reacted component. The reaction product may contain partially reacted intermediates or products that represent the reaction of unequal molar amounts of A) and B). The reaction product may be formed directly by the reaction of A) and B) or may be formed by further reacting an intermediate formed by the reaction of A) and B).

Reacting A) and B) includes contacting only A) and B) or mixing A) and B) in the presence of one or more other compounds. Reacting A) and B) may be carried out in a single step or in multiple steps with or without isolating an intermediate component.

The invention further provides a process for preparing the catalysts and compounds of the invention. In this process at least one suitable organosilicon compound having at least one Si—N bond (compound A) is reacted with at least one suitable nucleophilic fluorination agent (compound B), if desired, in the presence of a solvating and/or complexing agent and/or phase transfer catalyst, at a temperature from −20° C. to 200° C.

Compounds A) suitable for preparing the catalysts and compounds of the invention are amino silanes, silyl ureas or silazanes or mixtures thereof, including methylaminotrimethylsilane, dimethylaminotrimethylsilane, dibutylaminotrimethyl-silane, diethylaminodimethylphenylsilane, bis(dimethyl-amino)dimethylsilane, bis(diethylamino)dimethylsilane, bis(dibutylamino)dimethylsilane, bis(dimethylamino)methylphenylsilane, N-methyl-N-trimethylsilyl-N′-methyl-N′-butylurea, N-trimethylsilyl-N-methyl-N′,N′-dimethylurea, N-trimethylsilyl-N-ethyl-N′,N′-dimethylurea, N-trimethylsilyl-N-butyl-N′-butyl-N′-trimethylsilylurea, trimethylsilylpyrrolidine, trimethylsilylmorpholine, trimethylsilylpiperidine, trimethylsilylpiperazine, hexamethyldisilazane, heptamethyldisilazane, 1,3-diethyl-1,1,3,3-tetramethyl-disilazane, hexaethyldisilazane, and 1,3-diphenyl-1,1,3,3-tetramethyldisilazane.

Compounds B) suitable for preparing the catalysts and compounds of the invention are alkali metal fluorides and alkaline earth metal fluorides, including potassium fluoride, cesium fluoride, phosphazenium fluorides such as, for example, 1,1,1,3,3,3-hexakis(dimethylamino)diphosphazenium fluoride (literature: R. Schwesinger et al., Angew. Chem. 103, 1991, 1376-1378), aminophosphonium fluorides of the general formula (III)

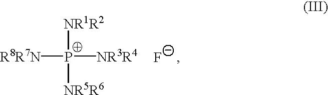

where R¹, R², R³, R⁴, R⁵, R⁶, R⁷, and R⁸ are branched or else unbranched aliphatic, optionally alkoxy-substituted alkyl radicals having from 1 to 8 carbon atoms and where in each case the pairings R¹ and R², R³ and R⁴, R⁵ and R⁶ and R⁷ and R⁸ may be linked to one another via an alkylene bridge, which where appropriate may also contain the heteroatoms O, S or N, such as, for example, bis(2-methoxyethyl)aminotris(pyrrolidino)phosphonium fluoride, bis(2-methoxyethyl)aminotris(piperidino)phosphonium fluoride, bis(2-methoxyethyl)aminotris(dimethylamino)phosphonium fluoride or morpholinotris(diethylamino)phosphonium fluoride, dialkyl-, diaryl- or alkylarylaminosulfur trifluorides such as, for example, bis(2-methoxyethyl)aminosulfur trifluoride or diethylaminosulfur trifluoride, and also tetraalkylammonium triphenyldifluorosilicates, triphenyldifluorostannates and hexafluorosilicates, such as, for example, tetrabutylammonium triphenyldifluorosilicate, tetrabutylammonium triphenyldifluorostannate and tetrabutylammonium hexafluorosilicate.

The catalysts and compounds of the invention can be prepared in situ whereby the catalyst is generated in the di- or polyisocyanate matrix that is to be trimerized. For this purpose, components A and B are admixed independently of one another with the corresponding di- or polyisocyanate. Alternatively, the catalyst components can first be reacted with one another outside the isocyanate matrix without solvent or in a solvent, and the catalyst prefabricated in this way. The preparation may take place in the presence of one or more solvating and/or complexing agents and/or phase transfer catalyst(s). Suitable complexing agents are polyethylene oxides; for example, ethylene glycol dimethyl ether or polyethylene glycol dimethyl ether; crown ethers such as dibenzo-18-crown-6 or N,N′-dibenzyl-4,13-diaza-18-crown-6, for example, or else cryptands such as, for example, 1,10-diaza-4,7,13,16,21-pentaoxabicyclo[8.8.5]tricosane. Suitable phase transfer catalysts are organic ammonium salts and phosphonium salts which are soluble in the polyisocyanate matrix.

The invention further provides for the use of the catalysts and compounds of the invention for trimerizing mono-, di- or polyisocyanates.

The invention provides, furthermore, a process for preparing polyisocyanates containing isocyanurate groups by catalytically induced trimerization of organic mono-, di- or polyisocyanates, the invention catalysts serve as the trimerization catalysts for these processes.

The invention further provides polyisocyanates prepared by the process of the invention and their use.

### DESCRIPTION OF THE PREFERRED EMBODIMENTS

In order to prepare the polyisocyanates of the invention it is possible to use any known aliphatic, cycloaliphatic, araliphatic, and aromatic mono-, di-, and polyisocyanates with an NCO content of less than 70 percent by weight in pure form or as any desired mixtures with one another. Examples include the following: cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanato-phenyl)methane, propane diisocyanates, butane diisocyanates, pentane diisocyanates, hexane diisocyanates (e.g., hexamethylene diisocyanate (HDI) or 1,5-diisocyanato-2-methylpentane (MPDI)), heptane diisocyanates, octane diisocyanates, nonane diisocyanates (e.g., 1,6-diisocyanato-2,4,4-trimethyl-hexane and 1,6-diisocyanato-2,2,4-trimethylhexane (TMDI)), nonane triisocyanates (e.g., 4-isocyanato-methyl-1,8-octane diisocyanate (TIN)), decane di- and triisocyanates, undecane di- and triisocyanates, dodecane di- and triisocyanates, isophorone diisocyanate (IPDI), bis(isocyanatomethylcyclohexyl)-methane (H₁₂MDI), isocyanatomethyl methylcyclohexyl isocyanates, 2,5(2,6)-bis(isocyanatomethyl)bicyclo-[2.2.1]heptane (NBDI), 1,3-bis(isocyanatomethyl)cyclo-hexane (1,3-H₆-XDI), and 1,4-bis(isocyanatomethyl)-cyclohexane (1,4-H₆-XDI). Any of the regioisomers and/or stereoisomers of the isocyanates may also be used. Preferred isocyanates are HDI, IPDI, MPDI, TMDI, 1,3- and 1,4-H₆-XDI, NBDI, and mixtures of HDI and IPDI.

Monoisocyanates can also be converted into isocyanurates in the presence of the catalysts of the invention; examples of monoisocyanates include ethyl isocyanate, cyclohexyl isocyanate, phenyl isocyanate, tolyl isocyanate, benzyl isocyanate, and all regioisomers and stereoisomers of the following compounds: propyl isocyanates, hexyl isocyanates, octyl isocyanates, and methoxypropyl isocyanate.

In the process of the invention, the synthesis route by which the isocyanate used has been prepared, i.e., with or without the use of phosgene, is unimportant. It should be noted, however, that the amount of catalyst needed to achieve a desired NCO content depends, among other things, on the quality of the mono-, di- or polyisocyanate. An increasing amount of hydrolyzable chlorine compounds in the isocyanate necessitates an increase in the amount of catalyst, and so an inhibitory effect of the hydrolyzable chlorine on the catalyst can be assumed.

Like aminosilyl compounds, various nucleophilic fluorination agents, including potassium fluoride and cesium fluoride, may also induce the trimerization of isocyanates (EP 0315 692; see Y. Nambu, T. Endo, J. Org. Chem. 1993, 58, 1932-1934). The catalysts of the invention however, have a higher trimerization activity. They may be deactivated chemically or thermally.

For the preparation of the inventive polyisocyanates containing isocyanurate groups it is unimportant whether the catalyst of the invention is soluble in the mono-, di- or polyisocyanate to be trimerized.

The preparation of the polyisocyanates containing isocyanurate groups by partial trimerization may be conducted continuously (tube reactor or tank cascade) or batchwise. The catalysts according to the invention are used at concentrations of between 0.01 and 5.0% by weight. The exact amount is dependent on the individual catalyst, on the target conversion, and on the process regime.

The trimerization may be conducted isothermally within a temperature range between 0° C. and 100° C., preferably between 20° C. and 80° C. The reaction may take place with quantitative reaction of the participating isocyanate groups of the starting (poly)isocyanate/mixture or may be interrupted at any desired degree of conversion. It is preferred to aim for a conversion of 10-50%. Once the desired conversion has been achieved, the trimerization is stopped by adding (sub)stoichiometric amounts of a deactivator. Compounds suitable for inhibiting the catalyst system include, for example, acids or acid derivatives such as HCl, organic sulfonic acids, or acidic esters of phosphorous acid and phosphoric acid.

The reaction regime may also be designed exothermally. In this case, the temperature of the reaction mixture containing the catalyst of the invention and the starting (poly)isocyanate or the starting (poly)isocyanate mixture is heated to 120-160° C., preferably to 80-120° C., for the purpose of initiating the exothermic trimerization. Alternatively, the ingredients needed to form the catalyst of the invention, or the catalyst in prefabricated form, may also be metered in after the starting (poly)isocyanate or the starting (poly)isocyanate mixture has reached the temperature necessary for initiation of the exothermic reaction. The exact temperature at which the exothermic reaction is initiated is a function, among other things, of the isocyanate, of the individual catalyst, and of the catalyst concentration, and can easily be determined experimentally. As a general rule, the catalyst of the invention is partially or completely thermally destroyed in the course of the exothermic trimerization, during which temperatures of up to 220° C. are reached. Progressive NCO loss of the products of the exothermic trimerization on storage, e.g., at 50° C., indicates that the thermal destruction of the catalyst was not quantitative. In this case, a chemical inhibitor must be added in order to deactivate the catalyst completely. The amount required can easily be determined experimentally.

The process of the invention can be conducted either solventlessly or with dilution of the mono-, di- or polyisocyanates or mixtures thereof. Compounds suitable for effecting dilution include in principle all organic compounds which are inert toward NCO groups, such as toluene, xylene(s), higher aromatics, ethers, and esters, for example. The solvent-free variant is preferred.

For preparing polyisocyanates containing isocyanurate groups, the catalysts of formula (I) according to the invention are preferably present in amounts of 0.01-5% by weight, more preferably 0.02-3% by weight, based on the weight of the starting (poly)isocyanate or starting (poly)isocyanate mixture(s) employed. The exact amount can easily be determined experimentally and is dependent on the catalytic activity of the individual catalyst, on the target conversion, and on the process regime. The trimerization may be conducted isothermally or exothermally, continuously or batchwise. Following chemical or thermal deactivation of the catalyst, the unreacted monomer, whether it be monoisocyanate, diisocyanate or low molecular mass polyisocyanate, can be separated off by short-path evaporation, thin-film evaporation or extraction and then used again. The removal of excess starting isocyanate(s) is preferable if the process products of the invention are intended for applications in the polyurethane coatings sector.

The invention also provides for the use of the isocyanurate-functional polyisocyanates, free from monomer, as intermediates for polyurethane coatings, for polyurethane dispersions, adhesives, and as a polyisocyanate component in 1- and 2-component polyurethane systems. Polyisocyanates that are free of monomer may be completely free of monomer or may contain up to 0.5% by weight of monomer.

The monomer-free isocyanurate-functional polyisocyanates prepared in accordance with the invention constitute useful intermediates for polyurethane coatings, i.e., leather coatings and textile coatings, and for polyurethane dispersions and adhesives, and are particularly valuable as polyisocyanate components in 1- and 2-component polyurethane systems for weather-stable and light-stable polyurethane coating materials. The process products of the invention may be used either as they are or in a form in which they have been blocked with blocking agents. Examples of suitable blocking agents include lactams such as ε-caprolactam, oximes such as methyl ethyl ketoxime or butanone oxime, triazoles such as 1H-1,2,4-triazole, readily enolizable compounds such as acetoacetates or acetylacetone, or else malonic acid derivatives, such as malonic diesters having 1-10 carbon atoms in the alcohol residues.

### EXAMPLES

The following examples are not meant to limit the invention unless indicated otherwise, all percentages are by weight. All of the reactions were carried out under a nitrogen atmosphere.

### Example 1

### In situ Preparation of the Catalyst and Trimerization

a) A mixture of 800 g of HDI, 1.2 g (0.15%) of cesium fluoride and 0.24 g (0.35%) of heptamethyldisilazane was slowly heated to 140° C. with stirring. After 1 hour it was allowed to cool to 80° C., 0.12 g (0.018%) of methanol was added for deactivation, and the mixture was filtered to remove the cesium fluoride. The trimer had an NCO content of 43.3% (approximately 24% conversion). Finally, the excess monomer was separated from the polyisocyanate by short-path evaporation. The demonomerized resin had an NCO content of 23.1%.

b) A mixture of 800 g of HDI and 2.4 ml of a 0.5-molar solution of 1,1,1,3,3,3-hexakis(dimethylamino)phosphazenium fluoride and 1.4 g (0.18%) of heptamethyldisilazane was carefully heated to 80° C. After 40 minutes the NCO content of the reaction mixture was 40.2% (about 36% conversion). The reaction was stopped by adding 5.8 g of a 2.5% strength solution of HCl in HDI, the reaction mixture was filtered, and excess monomer was separated off by short-path evaporation. The monomer-freed polyisocyanate had an NCO content of 22.2%.

c) A mixture of 800 g of HDI and 0.7 g (0.08%) of a tetrabutylammonium triphenyldifluorosilicate and 0.7 g (0.08%) of heptamethyldisilazane was carefully heated to 60° C. After 90 minutes the NCO content of the reaction mixture was 38.7% (about 40% conversion). The reaction was stopped by adding 2.4 g of a 2.5% strength solution of HCl in HDI, the reaction mixture was filtered, and excess monomer was separated off by short-path evaporation. The monomer-freed polyisocyanate had an NCO content of 21.9%.

### Example 2

### In situ Preparation of the Catalyst and Trimerization

a) A mixture of 800 g of IPDI and 6.4 ml of a 0.5-molar solution of 1,1,1,3,3,3-hexakis(dimethylamino)phosphazenium fluoride and 1.4 g (0.18%) of heptamethyldisilazane was carefully heated to 60° C. After 10 minutes at 60° C. the NCO content of the reaction mixture was 31.2% (about 33% conversion). The reaction was stopped by adding 10.1 g of a 2.9% strength solution of HCl in HDI, the reaction mixture was filtered, and excess monomer was separated off by short-path evaporation. The monomer-freed polyisocyanate had an NCO content of 17.7%.

### Example 3 (Comparative Example, Not Inventive)

a) A mixture of 1000 g of HDI and 10 g (1%) of heptamethyldisilazane was stirred at 140° C. for 2 hours. The reaction mixture was then cooled to room temperature and its NCO content was found to be 38.6% (corresponding to a conversion of about 40%). Following deactivation of the catalyst with 4 g of methanol, excess HDI was removed by short-path evaporation. The monomer-freed polyisocyanate had an NCO content of 21.8%.

b) A mixture of 800 g of HDI and 4 g (0.5%) of heptamethyldisilazane was stirred at 140° C. for 4 hours. The reaction mixture was then cooled to room temperature and its NCO content was found to be 40.1% (corresponding to a conversion of about 36%). Following deactivation of the catalyst with 1.6 g of methanol, excess HDI was removed by short-path evaporation. The monomer-freed polyisocyanate had an NCO content of 22.0%.

c) A mixture of 800 g of HDI and 8 g (1%) of heptamethyldisilazane was stirred at 100° C. for 8 hours. The reaction mixture was then cooled to room temperature and its NCO content was found to be 39.9% (corresponding to a conversion of about 36%). Following deactivation of the catalyst with 3.2 g of methanol, excess HDI was removed by short-path evaporation. The monomer-freed polyisocyanate had an NCO content of 21.9%.

### Example 4 (Comparative Example, Not Inventive)

A mixture of 800 g of IPDI and 8 g (1%) of heptamethyldisilazane was stirred at 100° C. for 2 hours. After no conversion was found, it was left stirring at 140° C. for a further 2 hours. The conversion was less than 3%. The reaction was terminated, and in view of the low conversion the reaction mixture was not worked up.

### Example 5 (Comparative Example, Not Inventive)

a) A mixture of 800 g of HDI and 1.2 g (0.15%) of cesium fluoride was heated to 100° C. and left at this temperature for 20 minutes. When no conversion could be ascertained, the temperature was raised further and the reaction mixture was stirred at 140° C. for 60 minutes. The conversion was less than 5%. The reaction was terminated, and in view of the low conversion the reaction mixture was not worked up.

b) A mixture of 800 g of HDI and 7 ml of a 0.5-molar solution of 1,1,1,3,3,3-hexakis(dimethylamino)phosphazenium fluoride was carefully heated to 80° C. After 30 minutes at 60° C. the NCO content of the reaction mixture was 40.1% (about 36% conversion). The reaction was stopped by adding 5.1 g of a 2.5% strength solution of HCl in HDI, and excess monomer was separated off by short-path evaporation. The monomer-freed polyisocyanate had an NCO content of 22.4%.

c) A mixture of 800 g of HDI and 1.3 g (0.16%) of a tetrabutylammonium triphenyldifluorosilicate and 1.4 g (0.18%) of heptamethyldisilazane was carefully heated to 80° C. After 2 hours the NCO content of the reaction mixture was 39.8% (about 36% conversion). The reaction was stopped by adding 3.5 g of a 2.5% strength solution of HCl in HDI, the reaction mixture was filtered, and excess monomer was separated off by short-path evaporation. The monomer-freed polyisocyanate had an NCO content of 22.3%.

German application 10159803.3 filed on Dec. 5, 2001 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

What is claimed as new and is intended to be secured by letters patent is:

1. A composition comprising the reaction product of
A) one or more compounds of formula I
R_{(4-q)}Si(NR¹R²)_{q} (I),
wherein q=1 or 2,
R, simultaneously or independently of one another, is a saturated or unsaturated, linear or branched aliphatic or cycloaliphatic radical or aryl, aralkyl, or alkylaryl radical having from 1 to 16 carbon atoms, wherein two R radicals can be linked with one another via an alkylene bridge,
R¹ is R, SiR₃ or an amide radical of formula (II) 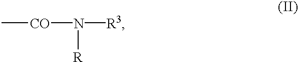
wherein R² is R or H, wherein R² may be linked to R¹ via an alkylene bridge when R₁ is not an amide,
R³ is R or SiR₃, and
B) one or more compounds selected from the group consisting of alkali metal fluorides, alkaline earth metal fluorides, phosphazenium fluorides, alkylarylaminosulfur trifluorides, dialkylaminosulfur trifluorides, diarylaminosulfur trifluorides, tetraalkylammonium triphenyldifluorosilicates, tetraalkylammonium triphenyldifluorostannates, tetraalkylammonium hexafluorosilicates, aminophosphonium fluorides of formula (III) 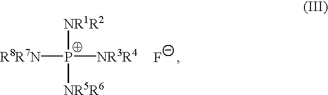
where R¹, R², R³, R⁴, R⁵, R⁶, R⁷, and R⁸ are branched or unbranched aliphatic, optionally alkoxy-substituted alkyl radicals having from 1 to 8 carbon atoms and where in each case the pairings R¹ and R², R³ and R⁴, R⁵ and R⁶, and R⁷ and R⁸ may be linked to one another via an alkylene bridge, which may contain one or more of the heteroatoms O, S or N,
and mixtures thereof,
in a ratio 1/100>A/B>100/1.

2. The composition as claimed in claim 1, wherein A comprises at least one amino silane, silyl urea or silazane.

3. The composition as claimed in claim 1, wherein A comprises at least one selected from the group consisting of methylaminotrimethylsilane, dimethylaminotrimethylsilane, dibutylaminotri-methylsilane, diethylaminodimethylphenylsilane, bis(dimethylamino)dimethylsilane, bis(diethyl-amino)dimethylsilane, bis(dibutylamino)dimethyl-silane, bis(dimethylamino)methylphenylsilane, N-methyl-N-trimethylsilyl-N′-methyl-N′-butylurea, N-trimethylsilyl-N-methyl-N′,N′-dimethylurea, N-trimethylsilyl-N-ethyl-N′,N′-dimethylurea, N-trimethylsilyl-N-butyl-N′-butyl-N′-trimethylsilylurea, trimethylsilylpyrrolidine, trimethylsilylmorpholine, trimethylsilyl-piperidine, trimethylsilylpiperazine, hexamethyldisilazane, heptamethyldisilazane, 1,3-diethyl-1,1,3,3-tetramethyldisilazane, hexaethyldisilazane 1,3-diphenyl-1,1,3,3-tetramethyldisilazane and a mixture thereof.

4. The composition as claimed in claim 1, wherein B comprises at least one selected from the group consisting of potassium fluoride, cesium fluoride and 1,1,1,3,3,3-hexakis(dimethylamino)diphosphazenium fluoride.

5. The composition as claimed in claim 1, wherein B comprises at least one selected from the group consisting of bis(2-methoxyethyl)aminotris(pyrrolidino)phosphonium fluoride, bis(2-methoxyethyl)aminotris(piperidino)phosphonium fluoride, bis(2-methoxyethyl)aminotris(dimethylamino)phosphonium fluoride, morpholinotris(diethylamino)phosphonium fluoride, bis(2-methoxyethyl)aminosulfur trifluoride, diethylaminosulfur trifluoride, tetrabutylammonium triphenyldifluorosilicate, tetrabutylammonium triphenyldifluorostannate and tetrabutylammonium hexafluorosilicate.

6. A process comprising
reacting an isocyanate selected from the group consisting of a mono-isocyanate, a di-isocyanate, a polyisocyanate or a mixture thereof, in the presence of the composition claimed in claim 1.

7. The process claimed in claim 6, wherein the isocyanate is an aliphatic, cycloaliphatic, araliphatic or aromatic isocyanate.

8. The process claimed in claim 6, wherein the isocyanate is selected from the group consisting of cyclohexane diisocyanates, methylcyclohexane diisocyanates, ethylcyclohexane diisocyanates, propylcyclohexane diisocyanates, methyldiethyl-cyclohexane diisocyanates, phenylene diisocyanates, tolylene diisocyanates, bis(isocyanatophenyl)methane, propane diisocyanates, butane diisocyanates, pentane diisocyanates, hexane diisocyanates, hexamethylene diisocyanate (HDI), 1,5-diisocyanato-2-methylpentane (MPDI), heptane diisocyanates, octane diisocyanates, nonane diisocyanates, 1,6-diisocyanato-2,4,4-trimethylhexane, 1,6-diisocyanato-2,2,4-trimethylhexane (TMDI), nonane triisocyanates, 4-isocyanatomethyl-1,8-octane diisocyanate (TIN), decane di-isocyanate, decane triisocyanate, undecane di-isocyanate, undecane triisocyanate, dodecane di-isocyanate, dodecane triisocyanates, isophorone diisocyanate (IPDI), bis(isocyanatomethylcyclo-hexyl)methane (H₁₂MDI), isocyanatomethyl methylcyclohexyl isocyanates, 2,5(2,6)-bis(iso-cyanatomethyl)bicyclo[2.2.1]heptane (NBDI),1,3-bis(isocyanatomethyl)cyclohexane (1,3-H₆-XDI), 1,4-bis(isocyanatomethyl)cyclohexane (1,4-H₆-XDI) and a mixture thereof.

9. The process claimed in claim 6, wherein the isocyanate is selected from the group consisting of HDI, IPDI, MPDI, TMDI, 1,3-H₆-XDI, 1,4-H₆-XDI, NBDI, a mixture of HDI and IPDI and mixtures thereof.

10. The process claimed in claim 6, wherein the isocyanate is selected from the group consisting of ethyl isocyanate, cyclohexyl isocyanate, phenyl isocyanate, tolyl isocyanate, benzyl isocyanate, propyl isocyanates, hexyl isocyanates, octyl isocyanates, methoxypropyl isocyanate, regioisomers thereof and stereoisomers thereof.

11. The process as claimed in claim 6, wherein the process is carried out continuously or batchwise.

12. The process as claimed in claim 6, wherein the composition is present at a concentration of between 0.01 and 5.0% by weight.

13. The process as claimed in claim 6, wherein the process is carried out isothermally in a temperature range between 0° C. and 100° C.

14. The process as claimed in claim 6, wherein the process is carried out isothermally in a temperature range between 20° C. and 80° C.

15. The process as claimed in claim 6, wherein the isocyanate is trimerized.

16. A polyisocyanate having one or more isocyanurate groups, prepared by the process as claimed in claim 6.

17. A composition obtained by reacting
A) one or more compounds of formula I
R_{(4-q)}Si(NR¹R²)_{q} (I),
in which q=1 or 2,
R, simultaneously or independently of one another, represents a saturated or unsaturated, linear or branched aliphatic or cycloaliphatic radical or aryl, aralkyl, or alkylaryl radical having from 1 to 16 carbon atoms, wherein two R radicals can be linked with one another via an alkylene bridge,
R¹ is R, SiR₃ or an amide radical of formula (II) 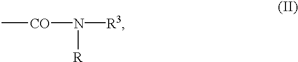
wherein R² is R or H, wherein R² may be linked to R¹ via an alkylene bridge when R¹ is not an amide radical, and
R³ is R or SiR₃, and
B) one or more compounds selected from the group consisting of alkali metal fluorides, alkaline earth metal fluorides, phosphazenium fluorides, alkylarylaminosulfur trifluorides, dialkylaminosulfur trifluorides, diarylaminosulfur trifluorides, tetraalkylammonium triphenyldifluorosilicates, tetraalkylammonium triphenyldifluorostannates, tetraalkylammonium hexafluorosilicates, aminophosphonium fluorides of formula (III) 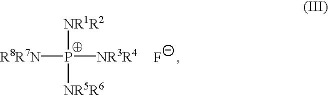
where R¹, R², R³, R⁴, R⁵, R⁶, R⁷, and R⁸ are branched or unbranched aliphatic, optionally alkoxy-substituted alkyl radicals having from 1 to 8 carbon atoms and where in each case the pairings R¹ and R², R³ and R⁴, R⁵ and R⁶, and R⁷ and R⁸ may be linked to one another via an alkylene bridge, which may contain the heteroatoms O, S or N,
and mixtures thereof,
in a ratio 1/100>A/13>100/1.

18. A process comprising
reacting
A) one or more compounds of formula I
R_{(4-q)}Si(NR¹R²)_{q} (I),
wherein q=1 or 2,
R, simultaneously or independently of one another, is a saturated or unsaturated, linear or branched aliphatic or cycloaliphatic radical or aryl, aralkyl, or alkylaryl radical having from 1 to 16 carbon atoms, wherein two radicals R can be linked with one another via an alkylene bridge,
R¹ is R, SiR₃ or an amide radical of formula (II) 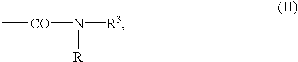
R² is R or H, wherein R² may be linked to R¹ via an alkylene bridge when R¹ is not an amide radical, and
R³ is R or SiR₃, and
B) one or more compounds selected from the group consisting of alkali metal fluorides, alkaline earth metal fluorides, phosphazenium fluorides, alkylarylaminosulfur trifluorides, dialkylaminosulfur trifluorides, diarylaminosulfur trifluorides, tetraalkylammonium triphenyldifluorosilicates, tetraalkylammonium triphenyldifluorostannates, tetraalkylammonium hexafluorosilicates, aminophosphonium fluorides of formula (III) 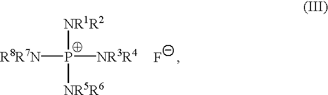
where R¹, R², R³, R⁴, R⁵, R⁶, R⁷, and R⁸ are branched or unbranched aliphatic, optionally alkoxy-substituted alkyl radicals having from 1 to 8 carbon atoms and where in each case the pairings R¹ and R², R³ and R⁴, R⁵ and R⁶, and R⁷ and R⁸ may be linked to one another via an alkylene bridge, which may contain one or more of the heteroatoms O, S or N,
and mixtures thereof,
in a ratio 1/100>A/B>100/1,
optionally in the presence of a solvating agent, complexing agent, phase transfer catalyst or a mixture thereof, at a temperature from −20 to 200° C.

19. The process as claimed in claim 18, wherein
A is at least one compound selected from the group consisting of an amino silane, a silyl urea, a silazane, methylaminotrimethylsilane, dimethylaminotrimethylsilane, dibutylaminotri-methylsilane, diethylaminodimethylphenylsilane, bis(dimethylamino)dimethylsilane, bis(diethyl-amino)dimethylsilane, bis(dibutylamino)dimethyl-silane, bis(dimethylamino)methylphenylsilane, N-methyl-N-trimethylsilyl-N′-methyl-N′-butylurea, N-trimethylsilyl-N-methyl-N′,N′-dimethylurea, N-trimethylsilyl-N-ethyl-N′,N′-dimethylurea, N-trimethylsilyl-N-butyl-N′-butyl-N′-trimethylsilylurea, trimethylsilylpyrrolidine, trimethylsilylmorpholine, trimethylsilyl-piperidine, trimethylsilylpiperazine, hexamethyldisilazane, heptamethyldisilazane, 1,3-diethyl-1,1,3,3-tetramethyldisilazane, hexaethyldisilazane 1,3-diphenyl-1,1,3,3-tetramethyldisilazane and a mixture thereof, and
B is at least one compound selected from the group consisting of potassium fluoride, cesium fluoride or 1,1,1,3,3,3-hexakis(dimethylamino)diphosphazenium fluoride, bis(2-methoxyethyl)aminotris(pyrrolidino)phosphonium fluoride, bis(2-methoxyethyl)aminotris(piperidino)phosphonium fluoride, bis(2-methoxyethyl)aminotris(dimethylamino)phosphonium fluoride, morpholinotris(diethylamino)phosphonium fluoride, bis(2-methoxyethyl)aminosulfur trifluoride, diethylaminosulfur trifluoride, tetrabutylammonium triphenyldifluorosilicate, tetrabutylammonium triphenyldifluorostannate and tetrabutylammonium hexafluorosilicate.

20. A process comprising
trimerizing an organic mono-isocyanate, di-isocyanate, polyisocyanate or mixture thereof, by reacting the isocyanate in the presence of a composition comprising the reaction product of
A) one or more compounds of formula I
R_{(4-q)}Si(NR¹R²)_{q} (I),
wherein q=1 or 2,
R, simultaneously or independently of one another, is a saturated or unsaturated, linear or branched aliphatic or cycloaliphatic radical or aryl, aralkyl, or alkylaryl radical having from 1 to 16 carbon atoms, wherein two radicals R can be linked with one another via an alkylene bridge,
R¹ is R, SiR₃ or an amide radical of formula (II) 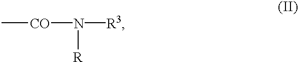
R² is R or H, wherein R² may be linked to R¹ via an alkylene bridge when R¹ is not an amide radical, and
R³ is R or SiR₃, and
B) one or more compounds selected from the group consisting of alkali metal fluorides, alkaline earth metal fluorides, phosphazenium fluorides, alkylarylaminosulfur trifluorides, dialkylaminosulfur trifluorides, diarylaminosulfur trifluorides, tetraalkylammonium triphenyldifluorosilicates, tetraalkylammonium triphenyldifluorostannates, tetraalkylammonium hexafluorosilicates, aminophosphonium fluorides of formula (III) 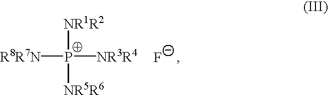
where R¹, R², R³, R⁴, R⁵, R⁶, R⁷, and R⁸ are branched or unbranched aliphatic, optionally alkoxy-substituted alkyl radicals having from 1 to 8 carbon atoms and where in each case the pairings R¹ and R², R³ and R⁴, R⁵ and R⁶, and R⁷ and R⁸ may be linked to one another via an alkylene bridge, which may contain one or more of the heteroatoms O, S or N,
and mixtures thereof,
in a ratio 1/100>A/B>100/1.

21. The process claimed in claim 20, wherein the isocyanate is an aliphatic, cycloaliphatic, araliphatic or aromatic isocyanate.

22. The process claimed in claim 20, wherein the isocyanate is selected from the group consisting of cyclohexane diisocyanates, methylcyclohexane diisocyanates, ethylcyclohexane diisocyanates, propylcyclohexane diisocyanates, methyldiethyl-cyclohexane diisocyanates, phenylene diisocyanates, tolylene diisocyanates, bis(isocyanatophenyl)methane, propane diisocyanates, butane diisocyanates, pentane diisocyanates, hexane diisocyanates, hexamethylene diisocyanate (HDI), 1,5-diisocyanato-2-methylpentane (MPDI), heptane diisocyanates, octane diisocyanates, nonane diisocyanates, 1,6-diisocyanato-2,4,4-trimethylhexane, 1,6-diisocyanato-2,2,4-trimethylhexane (TMDI), nonane triisocyanates, 4-isocyanatomethyl-1,8-octane diisocyanate (TIN), decane di-isocyanate, decane triisocyanate, undecane di-isocyanate, undecane triisocyanate, dodecane di-isocyanate, dodecane triisocyanates, isophorone diisocyanate (IPDI), bis(isocyanatomethylcyclo-hexyl)methane (H₁₂MDI), isocyanatomethyl methylcyclohexyl isocyanates, 2,5(2,6)-bis(iso-cyanatomethyl)bicyclo[2.2.1]heptane (NBDI), 1,3-bis(isocyanatomethyl)cyclohexane (1,3-H₆-XDI), 1,4-bis(isocyanatomethyl)cyclohexane (1,4-H₆-XDI) and a mixture thereof.

23. The process claimed in claim 20, wherein the isocyanate is selected from the group consisting of HDI, IPDI, MPDI, TMDI, 1,3-H₆-XDI, 1,4-H₆-XDI, NBDI, a mixture of HDI and IPDI and mixtures thereof.

24. The process claimed in claim 20, wherein the isocyanate is selected from the group consisting of ethyl isocyanate, cyclohexyl isocyanate, phenyl isocyanate, tolyl isocyanate, benzyl isocyanate, propyl isocyanates, hexyl isocyanates, octyl isocyanates, methoxypropyl isocyanate, regioisomers thereof and stereoisomers thereof.

25. The process as claimed in claim 20, wherein the process is carried out continuously or batchwise.

26. The process as claimed in claim 20, wherein the composition is present at a concentration of between 0.01 and 5.0% by weight.

27. The process as claimed in claim 20, wherein the process is carried out isothermally in a temperature range between 0° C. and 100° C.

28. The process as claimed in claim 20, wherein the process is carried out isothermally in a temperature range between 20° C. and 80° C.

29. The process as claimed in claim 20, wherein the isocyanate is trimerized.

30. The process as claimed in claim 20, wherein an isocyanate having at least one isocyanurate group is formed.

31. A polyisocyanate having one or more isocyanurate groups, prepared by the process as claimed in claim 20.

32. The process as claimed in claim 31, wherein the polyisocyanate is free from unreacted monomer.
